(19) United States
(12) Patent Application Publication
(10) Pub. No.: US 2013/0307499 A1
(43) Pub. Date: Nov. 21, 2013

(54) SWITHCED MODE POWER SUPPLY

(71) Applicant: HON HAI PRECISION INDUSTRY CO., LTD., NEW TAIPEI (TW)

(72) Inventor: YANG-SYUAN HUANG, NEW TAIPEI (TW)

(73) Assignee: HON HAI PRECISION INDUSTRY CO., LTD., NEW TAIPEI (TW)

(21) Appl. No.: 13/787,761

(22) Filed: Mar. 6, 2013

(30) Foreign Application Priority Data
May 18, 2012 (TW) 101117928

(51) Int. Cl. G05F 1/10

(52) U.S. Cl. CPC G05F 1/10
USPC 323/271

(57) ABSTRACT

A power supply includes an adapter, first, second, and third switches, a control circuit, and a pulse modulating chip. The second switch is connected to the first switch and a node. The third switch is connected to an output terminal via the node. The third switch is grounded. The control circuit is connected between the node and a first control end of the first switch. The pulse module is connected to a second control end of the second switch and a third control end of the third switch. The control circuit sends a control signal to the first control end to switch off the first switch after determining that a voltage of the node is low level for a period of time longer than a predetermined time.

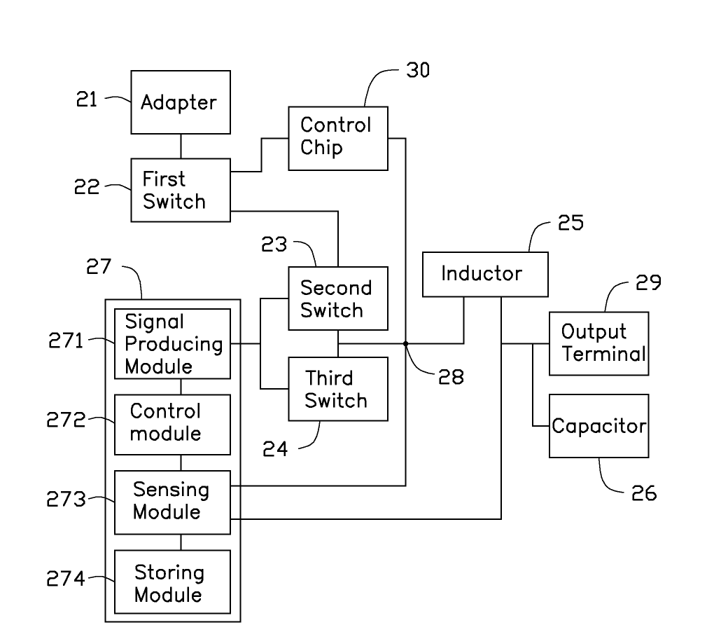

### BACKGROUND

The disclosure generally relates to power supplies, and particularly to a switched-mode power supply (SMPS).

### DESCRIPTION OF RELATED ART

An SMPS may include an adapter, two switches, an inductor, a capacitor, and a control chip. The control chip is connected to the two switches. The two switches can be switched on in turn after receiving a pulse signal. However, if either one of the two switches malfunctions, an over-current even may occur and damage electronic elements of the device employing the SMPS.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

The figure is a block diagram of a power supply of one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

The figure shows one embodiment of a power supply. The power supply includes an adapter 21, a first switch 22, a second switch 23, a third switch 24, an inductor 25, a capacitor 26, a pulse modulating chip 27, and a control circuit 30. The second switch 23 is switched on when receiving a high level voltage. The third switch 24 is switched on when receiving a low level voltage. In one embodiment, the model number of the pulse modulating chip 27 is OZ8389. The first switch 22, the second switch 23, and the third switch 24 may be field effect transistors, for example.

One terminal of the adapter 21 is connected to a power source (not shown). Another terminal of the adapter 21 is connected to a first end of the first switch 22. A second end of the first switch 22 is connected to a first end of the second switch 23. A second control end of the second switch 23 is connected to the pulse modulating chip 27. A second end of the second switch 23 is connected to a node 28. A first end of the third switch 24 is connected to the node 28. A third control end of the third switch 24 is connected to the pulse modulating chip 27. A second end of the third switch 24 is grounded. The control circuit 30 is connected between the node 28 and a first control end of the first switch 22. The node 28 is connected to a terminal of the inductor 25. The other terminal of the inductor 25 is connected to output terminal 29 and grounded via the capacitor 26.

The pulse modulating chip 27 includes a signal producing module 271, a control module 272, a sensing module 273, and a storing module 274. The signal producing module 271 is connected to the second control end of the second switch 23 and the third control end of the third switch 24. The signal producing module 271 is configured to produce a pulse signal to control the second switch 23 and the third switch 24. The storing module 274 stores a reference voltage value and a reference current value. The sensing module 273 is connected to the two terminals of the inductor 25 to obtain the voltage and current values of the inductor 25. The sensing module 273 is configured to compare the voltage and current values with the reference voltage and current values and send the comparison result to the control module 272. The control module 272 is configured to control the signal producing module 271 according to the result. If the result is that the voltage and current values are greater than the reference voltage and current values, the control module 272 controls the signal producing module 271 not to send the pulse signal to the second switch 23 and the third switch 24. The control circuit 30 is configured to obtain the voltage value of the node 28.

In use, the control circuit 30 obtains the voltage value of the node 28. When the voltage of the node 28 is low level for a period of time longer than a predetermined time, the control circuit 30 sends a control signal to the first control end of the first switch to be switched off, thereby protecting other electronic elements.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A switched mode power supply, comprising:
an adapter, the adapter is configured to be connected to a power source;
a first switch, the first switch is connected to the adapter;
a second switch, the second switch is connected to the first switch and a node, and the second switch is switched on when a high level voltage is received;
a third switch, the third switch is connected to the node; the node is connected to an output terminal; the third switch is grounded; and the third switch is switched on when a low level voltage is received,
a control circuit, the control circuit is connected between the node and a first control end of the first switch; and
a pulse modulating chip, the pulse modulating chip is connected to a second control end of the second switch and a third control end of the third switch; the pulse modulating chip is configured to send a pulse signal to the second control end and the third control end to control the second switch and the third switch;
wherein the control circuit is configured to send a control signal to the first control end to switch off the first switch after determining that a voltage of the node is low level for a period of time longer than a predetermined time.

2. The switched mode power supply of claim 1, wherein the node is connected to the output terminal via an inductor.

3. The switched mode power supply of claim 2, wherein the pulse modulating chip comprises a signal producing module, a control module, a sensing module, and a storing module; the signal producing module is connected to the second control end and the third control end; the signal producing module is configured to produce the pulse signal; the storing module stores a reference voltage value and a reference current value; the sensing module is connected to two terminals of the inductor to obtain current voltage and current values of the inductor; the control module is configured control the signal producing module not to send the pulse signal to the second control end and the third control end after determining that the current voltage and current values are greater than the reference voltage value and the reference current value.

4. The switched mode power supply of claim 2, wherein a terminal of the inductor connected to the output terminal is grounded via a capacitor.

5. The switched mode power supply of claim 1, wherein the first switch is a field effect transistor.

6. The switched mode power supply of claim 1, wherein the second switch is a field effect transistor.

7. The switched mode power supply of claim 1, wherein the third switch is a field effect transistor.
